(19) United States
(12) Patent Application Publication
(10) Pub. No.: US 2014/0088865 A1
(43) Pub. Date: Mar. 27, 2014

(54) APPARATUS AND METHOD FOR PREDICTING ARRIVAL TIMES IN A TRANSPORTATION NETWORK

(71) Applicant: SIEMENS INDUSTRY, INC., Alpharetta, GA (US)

(72) Inventors: Eckart Thies, Maple Grove, MN (US); Dang Neng Vang, Brooklyn Center, MN (US)

(73) Assignee: SIEMENS INDUSTRY, INC., Alpharetta, GA (US)

(21) Appl. No.: 13/628,210

(22) Filed: Sep. 27, 2012

(51) Int. Cl. G01C 21/00

(52) U.S. Cl. 701/465

(57) ABSTRACT

A scheduling system is provided for improving the routing performance of a plurality of objects moving through a transportation network. In one preferred application, a train scheduling system is improved by using an artificial neural network (ANN) to determine the trains' arrival times at various points in the network. Real-time data collection is minimized by training the ANN using stored data regarding historical, previously run train routes. A train's particular physical characteristics are input to the ANN to predict the trains' arrival times at the particular destination within the network. Scheduling and routing functions may then be applied to the ANN output data to determine modified, train arrival times and to make routing changes to optimize the scheduling. Completed route information is continuously fed back to the ANN and the scheduling system to retrain the ANN, assimilate the latest route data and further optimize the system's scheduling performance.

### BACKGROUND OF THE DISCLOSURE

1. Field of the Invention

The invention relates to the performance and optimization of object transportation systems. In particular, arrival times and resulting schedules are predicted for the objects at selected nodes within the transportation network. This invention has a specific application to vehicular (train) control systems and may be used to enhance vehicular management and improve the efficiency of the overall vehicular system.

2. Description of the Prior Art

Prior art train management systems are designed to address a host of problems concerning the prediction of trains' progression over their routes. Specifically, human operators (dispatchers), possibly in conjunction with software-based movement planning tools within the Railroad Control Centers (RCCs), are continuously challenged in their attempts to predict a) the progressions of the trains over their routes (“performance”), and b) the actual arrivals times of the trains at any given location (“arrivals”). Accurate prediction of these criteria is important in the trains' future trip planning for a variety of reasons. In particular, train meets (at stations and crossings) and passes en route (at train sidings) must be accommodated such that two trains are not scheduled to be on the same track at the same time. Train scheduling is further complicated by the planning of connections between trains, e.g., by decisions whether to enforce or relax the meeting time, or by enabling requests for acceleration or deceleration, e.g., for fuel savings considerations. Thus, the accurate prediction of the train's performance or arrival is of great financial value for railroads in that more efficient railroad operation results in greater operational savings and track/train utilization.

However, accurate performance and arrival prediction is heavily dependent on numerous variables. Some of these variables are physical factors pertaining to the trains themselves, such as train behavior over grades and in turns, a locomotive's power, a train's weight and length, etc. Other variables to be considered are operational constraints such as schedule constraints, competing train priorities, train speed limitations, track blockages, weather, etc.

Three basic prediction models are presently relied upon by the railroad industry in predicting a train systems operation: 1) schedule progression, 2) analytical models based on train physics, and 3) statistical models.

With schedule progression, a train's schedule itself is used to estimate the arrival time of a train at a particular location. For example, if the schedule for a train leaving station A calls for its expected arrival at station B in one hour, then a one hour delay of the train's departure from station A results in an estimated arrival at station B is one hour later than that called for by the schedule. Thus the schedules themselves are shifted in predicting the arrival times at various points in the train network. While this method uses less information and is relatively inexpensive to implement, it is less accurate than other, more computationally rigorous methods as described below.

In the analytical model, train predictions are made based on real-time train data based on any of a number of variables, e.g., train weight, length, number and horsepower of the locomotives, track grade, etc. Although the analytical model is considered more accurate than the statistical model described below, accurate predictions using this model come at the high cost of consistently providing accurate, real-time data. For example, one freight train system may have as many as 36,000 miles of track on which with 5000 trains per day operate. There are significant costs associated with implementing data collection systems in addition to the transmission and analysis of all the data for each train, on each track within such a freight train system. Further, analytical algorithms often require local adjustments over time. Therefore, these systems often require tuning and retuning once traffic patterns or physics change, including accommodating seasonal changes within the system. In sum, the analytical systems provide a relatively more accurate prediction of train system operation. However, these systems operate more slowly due to the higher data collection and computational requirements. Further, these systems are more expensive because of the set-up, operation and maintenance costs associated with the data collection and computer systems required to implement them.

In the statistical model, statistics regarding past train operations, the train system's physical characteristics and other relevant data are collected and analyzed according to any of a number of statistical models, e.g., linear/non-liner regression, stochastic, Bayesian etc. In the simplest of examples, human dispatchers perform their own statistical approach by applying their own “experience” to solve problems a given transport situation. Statistical models require less data maintenance but are also considered less accurate.

Thus, a need exists in the art for an improved train system model that provides better arrival prediction capabilities at a lower cost. For example, artificial neural networks (ANNs) may be considered for inclusion in the modeling processes. ANNs provide a more accurate statistical model that permits the model to “learn” from its past operations through feed-forward and back propagation processes. See generally, Artificial Neural Networks for Civil Engineers: Fundamentals and Applications, American Society of Civil Engineers, 1997, ISBN 0-7844-0225-6, the contents of which are incorporated by reference herein in its entirety.

U.S. Pat. No. 6,125,311 to Lo (Lo) discloses one such use of ANNs within a railway system. In particular, Lo provides for two components, a railway operation predictor and a diagnosis means. The railway operation predictor takes as inputs a continuously updated train schedule, measured values of the railway operation state as well as other variables. From these, Lo's railway operation predictor generates anticipated values for the railway operational state variables including the train locations, speeds, and safety intervals. The diagnosis means then detects, records and diagnoses any discrepancies in the actual state variable values. Lo's use of ANNs occurs within the diagnosis means, and therefore does not participate in the actual prediction and forecasting of the overall railway operations.

In another publication, Forecasting Train Arrival Time Using Modular Artificial Neural Networks, Cho, Hanson and Rilett, Laurence, ASCE Conf. Proc. 245, 107 (2002), an ANN is used to forecast train arrival times for a particular highway-railroad grade crossing. The primary motivation in using Cho's system is to provide more certainty in providing the minimum required warning time to motorists at railway crossings. Cho's system is envisioned as replacing existing mechanical means of proving the minimum notice time to motorists at such crossings by challenging certain assumptions in a particular train's operation at crossings, such as constant train speed and consistent environmental conditions. However, Cho's system does not apply to predicting the general scheduling and operation of an entire railroad system, and as such, does not work with the system-wide variable and considerations required to make such predictions within a complete railroad system.

Thus, the need exists in the art to improve object movement systems, specifically railroad network operations, using ANNs as the primary prediction mechanism for the entire network of moving objects as provided herein.

### SUMMARY OF THE INVENTION

Accordingly, in one particularly preferred embodiment, a computer-implemented system is provided for predicting arrival times at nodes within a transport network for each of a plurality of objects moving between the nodes, the objects moving along travel routes between the nodes, the computer-implemented system having at least one computer including a processor and associated memory from which computer instructions are executed by the processor, the system comprising: a tracking module for receiving real-time, location data indicating a physical location of each object and associating an object identifier with each object; an object database, accessible by the tracking module, for storing historical tracking information including previous travel routes of objects within the network, the object database further storing the real-time location data and information regarding physical attributes of each of the objects; an artificial neural network module associated with a travel route between an origination node and a destination node, the artificial neural network module being trained by the historical tracking information of objects including previous travel routes of objects travelling between the origination and destination nodes, the artificial neural network module accessing the object database and predicting an arrival time at the destination node of one of the objects travelling on the travel route based on the physical attributes of the object; a scheduling module coupled to a schedule database, the schedule database storing the predicted arrival time and detecting deviations from an expected arrival time; a routing system for executing routing instructions based on the detected deviations; and a feed-back module for retraining the artificial neural network module based on a completed travel route of the object.

In particular preferred variations within the system, the objects are trains, the object identifiers are train numbers, and the travel routes are segments of train track provided for the trains between the origination and destination nodes. Further, the physical attributes include at least one of: a locomotive type, a locomotive horsepower, a number of loaded train cars, and a train weight; the historical tracking information includes data regarding previously traversed train track segments for particular trains having particular physical attributes; and the schedule database includes a plurality of train schedules, one for each of the trains, and the expected arrival times are arrival times of the trains at the destination nodes. In addition, the destination node is a train station or a railroad siding; the routing information includes at least one of track switch information and track signaling information; and the artificial neural network weights the historical tracking information with the physical attributes of the trains in predicting the arrival times.

In a particularly preferred method according to the present invention, a method is provided for predicting arrival times at nodes within a transport network for each of a plurality of objects moving between the nodes, the objects moving along travel routes between the nodes, the method performed using a computer-implemented system having at least one computer including a processor and associated memory from which computer instructions are executed by the processor, the method including: receiving real-time, input data regarding physical locations of each of the plurality of objects; associating an object identifier with each object; accessing an object database to obtain historical tracking information regarding previous travel routes of objects between origination nodes and destination nodes and physical attributes of the objects; predicting with an artificial neural network module an arrival time of one of the objects at a destination node based on the physical attributes, the artificial neural network being associated with a travel route between an origination node and the destination node; detecting deviations between expected arrival times of the objects based and the predicted arrival times with a schedule of arrival times for the objects, the schedule of arrival times and the expected arrival times being stored in a schedule database; executing routing instructions based on the detected deviations; and modifying the schedule of arrival times based on the detected deviations.

According to particularly preferred variations of the method, the method further includes: training the artificial neural network using historical tracking information regarding previous travel routes of objects between the origination nodes and destination nodes; the step of training includes the step of weighting the physical attributes; the method includes feeding back completed travel routes of the objects between the origination and destination nodes to the artificial neural network; and retraining the artificial neural network; or scheduling a new route for the object based on the detected deviations. Further, the objects are trains, the object identifiers are train numbers, and the travel routes are segments of train track provided for the trains between the origination and destination nodes.

In yet another preferred embodiment, a computer-implemented system is provided for predicting an arrival time of an object at a destination node within a transport network of a moving objects, the object moving along a travel route between an origination node and the destination node, the computer-implemented system having at least one computer including a processor and associated memory from which computer instructions are executed by the processor, the system including: an artificial neural network module associated with the travel route between the origination node and the destination node, the artificial neural network module being trained by historical tracking information including previous travel routes of objects travelling between the origination and destination nodes, the artificial neural network predicting an arrival time at the destination node of the object based on physical attributes of the object. In variations of this embodiment the many objects are trains, the object identifiers are train numbers, and the travel routes are segments of train tracks provided for the trains between the origination and destination nodes; the physical attributes include at least one of: a locomotive type, a locomotive horsepower, a number of loaded train cars, and a train weight; and the historical tracking information includes data regarding previously traversed train track segments for particular trains having particular physical attributes. Further, the destination node is a train station or a railroad siding.

The objects and features of the present invention may be applied jointly or severally in any combination or sub-combination by those skilled in the art.

### BRIEF DESCRIPTION OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, in which:

FIG. 1 shows a block diagram of the system of the present invention;

FIG. 2 shows a diagram of the ANN according to a preferred embodiment of the present invention;

FIG. 3 shows a train graph of actual train progression compared to an initial estimated train progression according to one preferred embodiment of the invention; and

FIG. 4 shows a comparison of an actual train run with a prediction of the same according to one preferred embodiment of the invention.

To facilitate understanding, identical reference numerals have been used, where possible, to designate identical elements that are common to the figures.

### DETAILED DESCRIPTION

To facilitate a clear understanding of the present invention, illustrative examples are provided herein which describe certain aspects of the invention. However, it is to be appreciated that these illustrations are not meant to limit the scope of the invention, and are provided herein to illustrate certain concepts associated with the invention.

It is also to be understood that the present invention may be implemented in various forms of hardware, software, firmware, special purpose processors, or a combination thereof. Preferably, the present invention is implemented in software as a program tangibly embodied on a program storage device. The program may be uploaded to, and executed by, a machine comprising any suitable architecture. Preferably, the machine is implemented on a computer platform having hardware such as one or more central processing units (CPU), a random access memory (RAM), and input/output (I/O) interface(s). The computer platform also includes an operating system and microinstruction code. The various processes and functions described herein may either be part of the microinstruction code or part of the program (or combination thereof) which is executed via the operating system. In addition, various other peripheral devices may be connected to the computer platform such as an additional data storage device and a printing device.

It is to be understood that, because some of the constituent system components and method steps depicted in the accompanying figures are preferably implemented in software, the actual connections between the system components (or the process steps) may differ depending upon the manner in which the present invention is programmed. Specifically, any of the computers or devices may be interconnected using any existing or later-discovered networking technology and may also all be connected through a lager network system, such as a corporate network, metropolitan network or a global network, such as the internet.

The entire description below is provided in the particular context of a railroad transportation system. However, the invention of the present application is generally applicable to any object transportation system in which estimated arrival times of the objects are to be determined at particular points in the transportation network. The transportation network itself may be simply described as an interconnected set of nodes where each of the objects traverses the network, one segment at a time from a segment origination node to a segment destination node, in sequence, segment-by-segment to complete an entire trip. In the example using trains, the travel routes are the train tracks and the nodes may be train stations, track crossings, train sidings or any other arbitrary point along the network of train tracks.

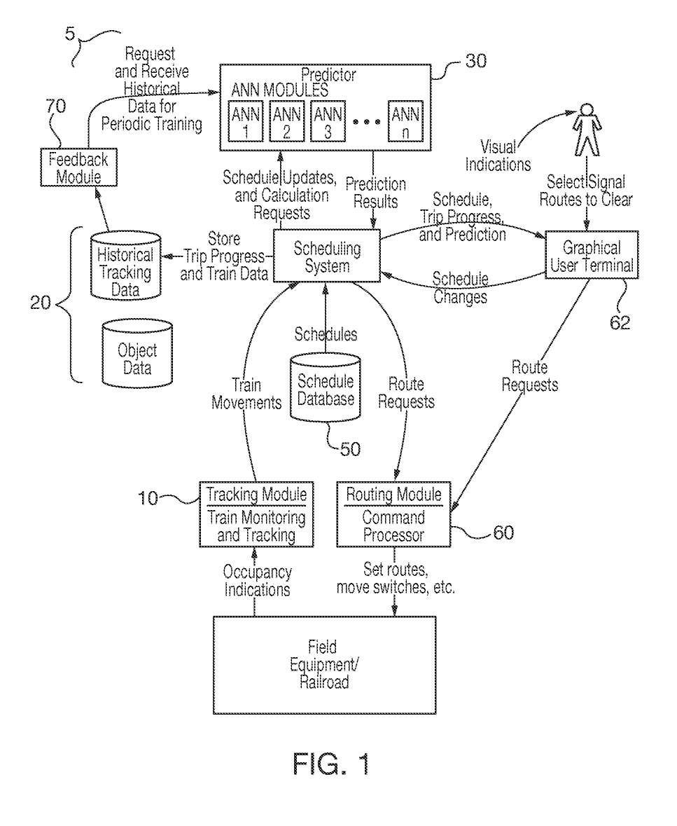

As shown in FIG. 1, an overall, software-based system 5 is presented for estimating arrival times within object transportation. The system includes a number of interoperable software-programmed modules and related databases including tracking module 10, an object database 20, a plurality of artificial neural network (ANN) modules 30, a scheduling module 40, a scheduling database 50, a routing module 60 and a feedback module 70. These modules and data may all be contained on one physical computer system or may be distributed among numerous and geographically separate computer-based, program executing resources. In one particular embodiment, tracking module 10, scheduling module 40, routing module 60, and feedback module 70 are singular and are globally applied to and operate on the entire transportation network. In this embodiment, two ANN modules are provided for each travel route (i.e., transportation segment between two nodes), one to operate in connection with each direction of travel between the nodes.

Tracking module 10 is provided to validate the identity of each train and to monitor the physical locations of the trains, particularly when residing at one of the railroad system nodes. Train identification may be as simple as verifying the train number and matching that number with the appropriate train described in the object database 20. Train number identification can be communicated upon request by the tracking module, for example through wireless communication technologies. Alternatively, visual recognition systems may be employed at certain points in the railroad nodes to automatically detect and report the train number, as presented on the engine's exterior, to the system. The monitoring of train's physical locations within the systems may be accomplished by any of a number of presently-known or later developed location provision techniques. Among the more recently developed technologies for this purpose include the global position tracking systems (UPS) which provide location accuracy to within several meters. A GPS receiver may be located on the train's engine or may be part of a mobile communication device within the train or in possession of the train conductor. Wireless communication between the UPS receiver and the transportation system may be conducted to establish the location of the train as a system input. Alternatively, more conventional train location technologies may be used to determine a train's location. Traditional systems may include any of the numerous electro-mechanical means that detect the presence of a train's axle through electrical shorting. In any case, these location determination systems may be applied on a per-train, or even a per-train car basis depending on the positioning accuracy desired and the system cost constraints.

Object database 20 is coupled to and accessible by tracking module 10 and ANN modules 30. Object database 20 records current tracking information provided by tracking module 10 and stores two critical sets of data: historic train tracking information and the physical characteristics of each train in the railroad network. The historical train tracking information consists of all the historical data relevant to the prediction of arrival times for past train trips on particular railroad routes between each pair of nodes. As one specific example, the following information may be stored for a particular, historical train run between two train stations: the train's physical characteristics (weight, length, number of engines, horsepower of locomotives etc.), the route's physical track data (number of inclines, grade of the track at certain points, speed or weight restrictions at certain track locations etc.), and optionally, non-fixed track route conditions(weather conditions, track blockages, etc.). As described below, this historical tracking information is provided as training data to the ANNs assigned to that specific segment of track route.

The second set of data stored within the object database is the actual train data for the trains within the railroad system. In one particularly preferred embodiment, 21 pieces of separate data are stored for each train:

1) Train type—e.g., passenger, freight, coal, Amtrak (any which may be derived from the train Id of a train, indicated by a letter). Within any class additional train types may be distinguished. For example, within freight trains—autos, manifest (containers), bulk (coal, sulfur, grain, potash) and such may be distinguished in order to determine train priorities;

2) Train Id substring—Often used to identify a certain “daily Run”, i.e., route between origin and destination, e.g., Port of Vancouver to rail yard in Edmonton (which may be derived from the first few numbers in a train Id);

3) Total rated horsepower of train's locomotives;

4) Train weight (tons);

5) Train length (feet);

6) Number of loaded train cars;

7) Number of empty train cars;

8) Presence of special dimension train cars—signifying the presence of extra high or extra wide cars which may experience certain track restrictions(otherwise 0 if we don't have the information);

9) Additional information (e.g., number) regarding exceptional dimensional loads of the train card (if any);

10) Presence of hazardous material cars (otherwise 0 if we don't have the information);

11) Additional information (e.g., number) regarding the hazardous material in the train cars (if any);

12) Presence of train cars having heavy axle loads (value zero if no information is available);

13) Additional information (e.g., number) regarding any train cars having heavy axle loads (if any);

14) Presence of train cars with speed restrictions (otherwise 0 if we don't have the information);

15) Additional information (e.g., number) regarding train cars with speed restrictions (if any);

16) Presence of train cars having a maximum speed (otherwise 0 if we don't have the information);

17) Additional information (e.g., number) regarding train cars having a maximum speed (if any);

18) Presence of cars with maximum speeds (value zero if no information is available);

19) Additional information (e.g., known speed restrictions) regarding the maximum speed of the train (if any);

20) Train status (late, on time); and

21) Deviation of the train—amount of time the train is late or early.

The above-recited list of stored train data was empirically generated as part of the prototype testing of the present invention. This list is not considered to be complete, exclusive, exhaustive or otherwise critical to the operation of the invention since any number of different inputs may be input to the ANN modules at the next processing stage. In addition, certain data, e.g., physical track data, may be stored on a per historical train run or on a global level. For example, the track characteristics remain constant for all train runs since the physical characteristics of one track (e.g., grade) do not change between train runs). Further, entirely different object data would necessarily be considered in transportation systems other than a railroad system.

Continuing with FIG. 1, a plurality of ANNs is provided as part of the prediction system of the overall system 5. In one particular embodiment, one ANN module is created and trained for each train route (i.e., track segment) in each possible direction of travel on the train route. Thus, in the example of a railroad, two ANNs would be provided for each track segment between two nodes in the railroad system. The creation and use of ANNs is well known to those of skill in the art, and only a general description of the ANN function is presented herein with the specific aspects of ANN discussed as they relate to the claimed invention and its specific application to a railroad transportation network.

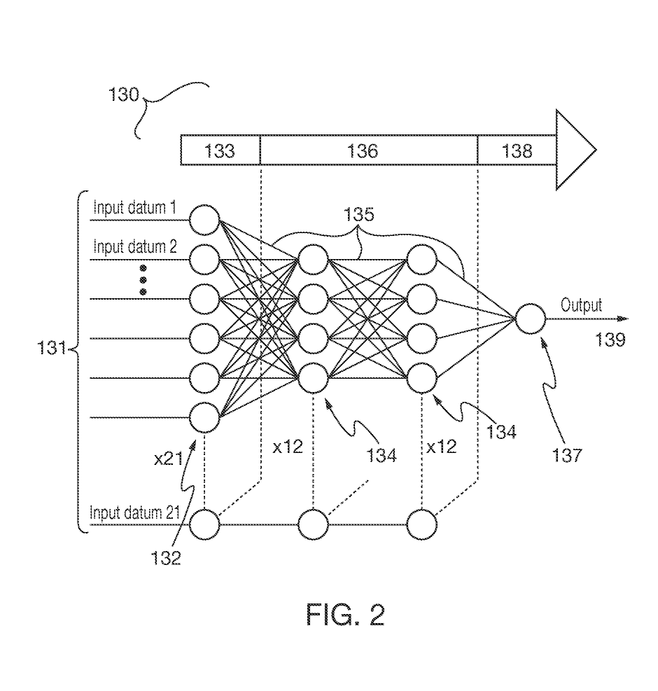

FIG. 2 shows an exemplary ANN of the present system. Structurally, the ANN consists of at least one layer of input nodes 132, one or more layers 134 of hidden nodes 136, and at least one output node 137 in a layer of output nodes 138. In theory, each ANN node in any layer takes inputs, weights them according to empirically determined weighting functions derived during the ANN training, to which a trigger function is applied to determine the node output. Node outputs may be a binary output (0 or 1) or a continuous normalized variable, typically between 0 and 1. All nodal outputs are then passed via internodal connections 135 to the next ANN layer section. With specific reference to FIG. 2 and the railroad system, inputs that are first linearly scaled are then provided, one per input node, at input layer nodes 132. The nodes then weight the input and apply a trigger function. Outputs from the input layer are then passed to the first layer of hidden nodes 134. Here, the interstitial inputs are again weighted and the trigger function is applied to the weighted inputs to provide an output. These node outputs are then are applied to the second layer of hidden nodes where another weighting is applied and the trigger function is executed. Finally, the second hidden layer outputs are provided to output node(s) or layer of the ANN for another round of weighting and trigger function application. The outputs from the output nodes provide another normalized value between 0 and 1, which may be scaled to fit the expected range of output data.

The structure of the ANN shown in FIG. 2 has been empirically determined as part of the optimization of the ANNs of the present invention as it applies to railroad networks. Specifically, a 21×12×12×1, multilayered, fully connected synapse structure has proved to be the best ANN to date for minimizing errors in predicting train arrivals. FIG. 2 provides only one example, however, and other ANN architectures may prove to be equally or even more accurate, particularly when using different input datasets. In sum, the structure of any particular ANN may be selected so as to achieve a certain result. In this example, however, the 21 unique inputs described above are provided to the ANN of FIG. 2. The ANN includes two hidden layers and each node of the ANN is fully connected to each of the nodes in the next, sequential processing layer. The output of each ANN is a normalized travel time indicating the travel time between transportation network nodes.

Prior to use, ANNs need to be trained in order to determine the nodes' weightings and trigger operations. This is accomplished by taking past operational data sets, specifically a set of actual operational inputs and outputs, and passing the inputs through the ANN to generate an output. The ANN uses its feed forward, back propagating characteristics in the following fashion to evolve to a steady-state of operation. Once the inputs are clamped the ANN iteratively operates to produce an output datum—a travel time in the example of the railroad network. Node input weightings are determined layer by layer to approximate the output. Errors from the first run of the first empirical set of data set are back propagated through the ANN, the weightings and triggers are adjusted, and new outputs are generated. This process is repeated for the first set of historical input data to achieve a minimal residual error. This process is repeated, multiply with each particular set of historical data and then across all sets of historical input data, until a certain number of iterations have been completed or a cumulative desired error function is minimized according to some criterion. Once the training phase is complete, the node input weights and trigger thresholds are fixed and the ANN enters the recognition phase. At this point, each node in the ANN has “learned” its expected operational characteristics and will provide highly accurate outputs in response to new sets of input data. Finally, as described in more detail below, feedback data from later completed train routes is fed back to the ANN after route completion as part of a continuous training process for the ANN.

A very limited numerical example is provided as guidance in understanding the ANN operation in the context of the railroad system. Assume that the first, top node in the input layer of FIG. 2 is for inputting the weight of the train as retrieved from object database 20. Prior to ANN input, data is linearly normalized using the training set which contains trains of weights between 50 and 100 tons. In this example, the following numbers would be used as inputs for the corresponding weight: 50 tons≦0.0, 75 tons≦0.5, 100 tons≦1.0. All other train weight input values would similarly scale linearly between 0.0 and 1.0 for weight values between 50 and 100. At the input node, each of these normalized input datum are weighting and a linear trigger function is applied. In the particular example provided, the input node uses a linear weighting function: y=a*x—where a is the weighting value fixed and learned by the ANN, x is the input value and y is the output value. Since the ANN is fully connected, the output from each node of the input layer is presented to each node of the first hidden layer as inputs. The inputs are weighted by the final weighting applied to those node input at the conclusion of the ANN training process. A sigmoid function is used as the trigger function to provide a continuous variable output of between 0 and 1. In the particular example provided, the sigmoid function is y=1/(1+ê−x). This process is repeated at every other node within the first hidden layer. These results are passed to the nodes of the second hidden layer where the process repeats itself using the particular weights resulting from the training of those nodes and the application of the sigmoid trigger functions. Finally, all the outputs of the second hidden layer are provided to the output node which again weights the input applies a linear trigger function as with the input nodes, and provides one normalized output of expected travel time. To get to the actual, un-normalized value, the expected range of values used in the training set is considered and linear transformation is again applied. For example, if the travel times between the two railroad network nodes being evaluated were between 5 and 10 minutes, and the normalized output from the output layer is 0.5, then the actual time value would be 7.5 minutes.

Returning to FIG. 1 and the overall system operation input physical train attributes from the object database are provided to the relevant ANNs for each of the plurality of train routes (Le., trip segments) that the train will take as part of a fully scheduled trip. The output times for each train route from the ANN are presented to the scheduling module 40. Scheduling module takes the per segment, train route travel times to create a train diagram and schedule of the expected, full train trip prior to the traversal of the first segment. This preliminary schedule is provided to a schedule database 50 coupled to and accessible by scheduling module 40. The schedule database stores all original and updated train schedules. As schedules are created and updated as part of the overall system operation, scheduling module 40 determines the best routes for the trains in order to optimize the continuous operation of the railroad system. Deviations from the initial expected train schedules are detected by the scheduling module, which then issues requests to the ANNs to recalculate train travel times and updates the train schedules to reflect these new data, by for example, offsetting train arrival and departure predictions.

A routing module 60 is provided within system 5 and is coupled to scheduling module 40 from which it received the continuous flow of updated train schedules. The routing module executes the actual routing instructions provided by the scheduling system such as the setting the proper track switches and providing appropriate signal commands on the tracks. The routing system may be fully computer driven, human operated or a combination of both.

Finally, completed train trips, as recorded by the final train schedule, are provided to the object database along with accompanying data such as external variables and condition data collected during the train trip. These schedules and data are later represented to the relevant ANNs by the feedback module 70 during retraining cycles so as to fine tune the ANNs and more accurately predict the overall system operation and train arrival times. This computationally intensive retraining operation may take place in the evenings or other periods of low system use so as to minimize an impact on real-time system performance.

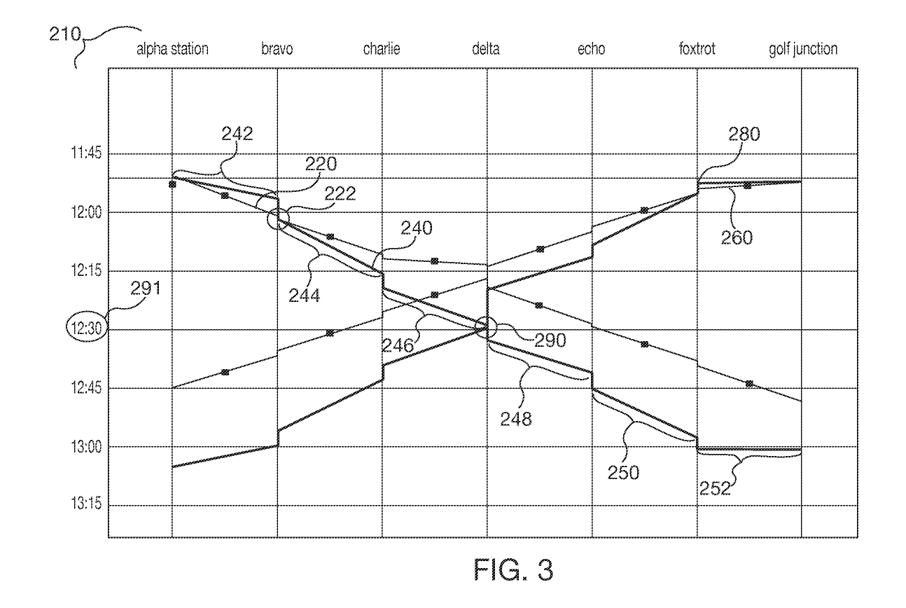

FIG. 3 shows the schedule 210 of actual train progression compared to initial, estimated schedules for two different trains travelling in opposite directions on the same track. This schedule is created by the scheduling module 40 and stored in scheduling database 50. Time is shown on the vertical axis and proceeds forward as the axis is traversed downwards. Track location is provided on the horizontal axis, with stations, and stopping points or other network nodes identified by name. Train A begins its trip at Alpha Station at approximately 11:52:30 AM and is scheduled to travel to Golf Junction. Train B begins its trip at Golf Junction at approximately 11:52:30 AM and is scheduled to travel to Alpha Station. Both trains' initial estimated schedules are indicated by lines containing the block markers. The initial estimated schedules may be provided manually by the system operators or automatically calculated by the apparatus and processes provided for in the present invention.

The actual travel schedules are updated in real-time by the railroad management system when new information is received. It is important to realize that any one train graph shows the estimated versus actual travel of the trains only at that one moment in time. When system information and determined train locations are updated, then updated train graphs and schedules are created by the ANNs 30 and scheduling module 40. For example, the actual train schedule for trains A and B are shown by train travel graphs (lines) 240 and 280. When trains reach network nodes and their actual position and time is conveyed by the system hardware on site to tracking module 10, these train travel graphs (lines) are updated from that temporal point forwards. The completed travel segments are stored by the scheduling module 40 in scheduling database 50 for future retraining of the ANNs 30.

By way of example, assume that the train graph of FIG. 3 depicts the real-time schedule of Trains A and B at 12:30:00 PM, depicted by time index 291 and location position 290. It can be seen that both trains are at Delta (a railroad network node) at this point in time. This is indicated by the vertical lines on the actual train paths at Delta for a time period beginning slightly before 12:30:00 PM and extending up until that time. At 12:30 PM, Train B departs Delta travelling towards Charlie. Slightly later, Train A departs Delta travelling towards Echo. As of temporal reference point 291, the scheduling module, 12:30:00 PM has created the following schedule information: past travel information for both trains in arriving at Delta and estimated future scheduling information for the remainder of the trains' trips. Regarding past scheduling information, three route segments for Train A's travel have been previously calculated, and are shown as the actual traversed train routes between respective nodes at graph segments 242, 244, and 246. Once Train A reached Delta, and any departure times were resolved by the scheduling module to accommodate both trains A and B departing the same node without conflict, the next three train routes segments 248, 250 and 252 were calculated by the scheduling module 40 using the ANNs 30 for those segments. The same past and predicted future scheduling is shown as provided by the scheduling module for Train B along graphic line 260.

Referring to the travel schedule for Train A, a few points are worth noting. In the initial travel segment 242, Train A progressed on this train route faster than the initial estimated schedule. This is indicated by the earlier arrival at Bravo than estimated. Once at Bravo and the train's position there was positively determined by the tracking module 10, scheduling module 40 recalculated the remaining five train routes using the ANNs for those five segments. It should be noted that the train graph depicted in FIG. 3 is assumed to be the active graph at time 12:30:00 PM, so it is possible, if not probable, that the estimated graph for train routes at 244, 246, 248, 250 and 252 created by the scheduling module at about 12:00:00 PM may have looked different than those shown in FIG. 3. Nevertheless, scheduling module 40 held the train there until the original expected departure time and Train A progressed towards Charlie where it arrived a bit later than expected. At each railroad network node, the physical presence of Train A is verified by the tracking module 10. Any physical train changes, e.g., removed cars, added locomotives, cargo emptied from cars etc., are noted and stored in the physical attributes portion of the object database. The scheduling module 40 then directs the ANNs 30 to recalculate the predicted arrival times at the remaining railroad nodes for the remainder of the train route segments. The scheduling module stores the updated schedule in the schedule database and the routing system executes the necessary, physical routing commands to achieve the updated predicted schedule and avoid any occupancy conflicts. This process is repeated by system 5 for each train as each railroad node is traversed.

It should be noted that the system described above attempts to minimize the frequency and quantity of real-time input data from overall railroad system. In this regard, more sensors (e.g., in between railroad nodes), more data collection (e.g., inputting real-time weather reports) and other date enhancements may be provided within added to the system to improve its prediction accuracy.

The train graphs created by the scheduling module shown in FIG. 3 are envisioned to have an added value in a computerized scheduling environment, and in particular through the use of graphical user interface at (GUI), for example at terminal 62. In particular, a drag-and-drop GUI may be incorporated into the graphical presentation means of the schedule such that train routes are not only calculated and presented, but then are also available for graphical modification and manipulation by system operators. Train conductors can alter their schedules directly from the trains, for example if train data changes (e.g., more cars are added than expected increasing the node stay time and delaying the predicted schedule). System operators managing the entire railroad network can drag-and-drop scheduling changes, delays, stoppages etc. directly within the GUI to effect the scheduling changes throughout the overall system.

Therefore, the use of ANNs within a railroad network enables the network to be modeled in a statistical manner by weighting its predicted arrival time according to input physical train information. This model has been shown to be superior over the above-described prior art physical and statistical models in the following regards and for the following reasons:

Accuracy: The ANN model performs statistical computations of previous train runs, weighed by accessible physical train data. The empirically tested results provide train performance predictions that are considered more accurate than with previous models. In fact, accuracies in the range of 2% have been achieved by using the above-described invention to predict train arrivals;

Flexibility: the ANN model permits the easy addition of variables affecting the train schedules as they become available and are identified as relevant; variables that improve accuracy of the predictions provided by the system;

Self-learning: by taking historic performance data in consideration and feeding back more recent performances, the system can be retrained when the traffic patterns, physical network conditions or other external network factors, like seasons, change. This computationally intensive retraining can take place when the system is offline such as the middle of the evenings, no to not affect real--time operations.

Data minimization: In its most fundamental embodiment, the system requires only minimal deployment of sensors at railroad nodes, on selected track sections and subdivisions thereof and at select points on the track terrain. Variations in territory and train performance over such territory are addressed, indirectly, thereby compensating for the absence of physical track data. The system permits local special adjustments (e.g., long trains over mountainous terrain vs. flats) thereby permitting the system to localize and retrain only certain route predictions.

Efficiency: Once trained, the ANNs computational capability in predicting arrival times at network nodes is almost instantaneous, thereby freeing up computational resources for other system purposes.

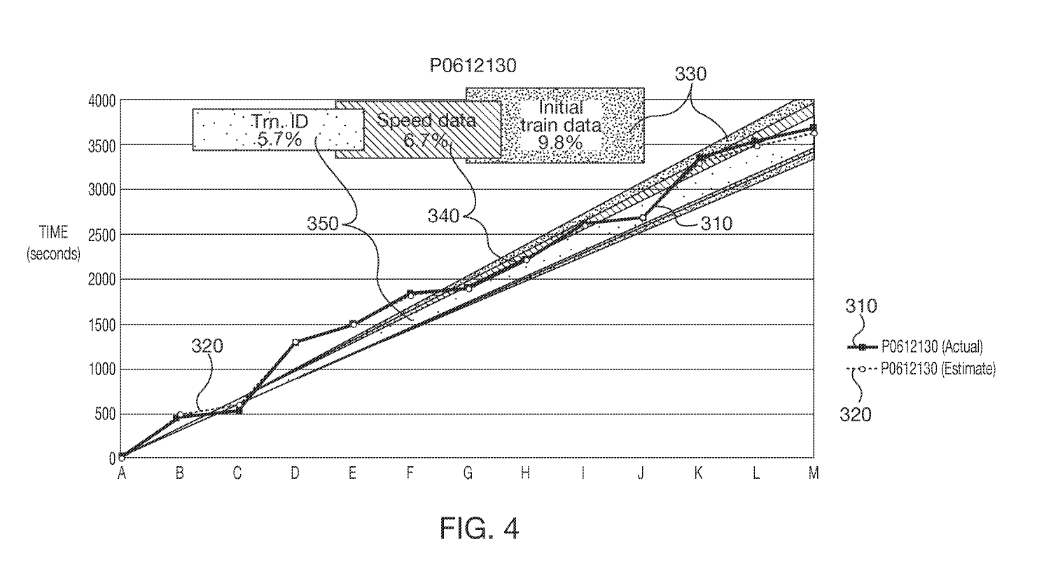

As shown in FIG. 4 the benefits of the ANN prediction model are shown according to one simulated output of the present invention. Actual train arrival times are shown as the solid line 310 while the estimated times are shown as dashed line 320. Three groups of variables are shown as being used as system inputs: initial train data 330, the speed data 340 and the train id 350. In this example and trial run, initial train data 330 included the following data from the list of 21 above: a) train type; b) rated horsepower; c) weight; d) length; e) number of loaded train cars; f) number of empty train cars; g) whether or not train has dimensional load cars; h) number of dimensional load cars or 0 if unknown; i) whether or not train has hazardous material cars; j) number of hazardous material cars or 0 if unknown; k) whether or not train has heavy axle load cars; l) number of heavy axle load cars or 0 if unknown; m) deviation of train from the schedule in terms of time; and n) train status (late or on time). Speed data 340 is then added in the next set of applied inputs, which in addition to the above used: o) whether or not train has speed restricted cars; p) number of speed restricted cars or 0 if unknown; q) whether or not train has maximum speed information; r) maximum speed of train cars or 0 if unknown; s) whether or not the maximum speed of the train is known; t) max speed of train or 0 if unknown. Finally, once train IDs 350 are included, u) train id substring, and are added addition to all the above the final band of probability about the expected arrival times are achieved.

As shown by the narrowing bands of probabilistic variation along the train's progress from node A to node M, the addition of each additional variable set to the ANN prediction system increasingly tightens the band of variation around the estimated arrival times. Empirical evidence has shown that the band of such variation may be reduced such that predictive system was capable of reliably predicting over 45% of the arrival times within a 2% margin of error and over 80% of all predictions arrival times were accurate within a 10% margin of error.

Although various embodiments, which incorporate the teachings of the present invention have been shown and described in detail herein, those skilled in the art can readily devise many other varied embodiments that still incorporate these teachings.

What is claimed is:

1. A computer-implemented system for predicting arrival times at nodes within a transport network for each of a plurality of objects moving between said nodes, said objects moving along travel routes between said nodes, said computer-implemented system having at least one computer including a processor and associated memory from which computer instructions are executed by said processor, said system comprising:
a tracking module for receiving real-time, location data indicating a physical location of each object and associating an object identifier with each object;
an object database, accessible by said tracking module, for storing historical tracking information including previous travel routes of objects within said network, said object database further storing said real-time location data and information regarding physical attributes of each of said objects;
an artificial neural network module associated with a travel route between an origination node and a destination node, said artificial neural network module being trained by said historical tracking information of objects including previous travel routes of objects travelling between said origination and destination nodes, said artificial neural network module accessing said object database and predicting an arrival time at said destination node of one of said objects travelling on said travel route based on said physical attributes of said object;
a scheduling module coupled to a schedule database, said schedule database storing said predicted arrival time and detecting deviations from an expected arrival time;
a routing system for executing routing instructions based on said detected deviations; and
a feed-back module for retraining said artificial neural network module based on a completed travel route of said object.

2. The system of claim 1 wherein said objects are trains, said object identifiers are train numbers, and said travel routes are segments of train track provided for said trains between said origination and destination nodes.

3. The system of claim 2 wherein said physical attributes include at least one of: a locomotive type, a locomotive horsepower, a number of loaded train cars, and a train weight.

4. The system of claim 2 wherein said historical tracking information includes data regarding previously traversed train track segments for particular trains having particular physical attributes.

5. The system of claim 2 wherein said schedule database includes a plurality of train schedules, one for each of said trains, and said expected arrival times are arrival times of said trains at said destination nodes.

6. The system of claim 2 wherein said destination node is a train station or a railroad siding.

7. The system of claim 2 wherein said routing information includes at least one of track switch information and track signaling information.

8. The system of claim 2 wherein said artificial neural network weights said historical tracking information with said physical attributes of said trains in predicting said arrival times.

9. A method of predicting arrival times at nodes within a transport network for each of a plurality of objects moving between said nodes, said objects moving along travel routes between said nodes, said method performed using a computer-implemented system having at least one computer including a processor and associated memory from which computer instructions are executed by said processor, said method comprising:
receiving real-time, input data regarding physical locations of each of the plurality of objects;
associating an object identifier with each object;
accessing an object database to obtain historical tracking information regarding previous travel routes of objects between origination nodes and destination nodes and physical attributes of said objects;
predicting with an artificial neural network module an arrival time of one of said objects at a destination node based on said physical attributes, said artificial neural network being associated with a travel route between an origination node and said destination node;
detecting deviations between expected arrival times of said objects based and said predicted arrival times with a schedule of arrival times for said objects, said schedule of arrival times and said expected arrival times being stored in a schedule database;
executing routing instructions based on said detected deviations; and
modifying said schedule of arrival times based on said detected deviations.

10. The method of claim 9 further comprising:
training said artificial neural network using historical tracking information regarding previous travel routes of objects between said origination nodes and destination nodes.

11. The method of claim 10 wherein said step of training includes the step of weighting said physical attributes.

12. The method of claim 10 further comprising:
feeding back completed travel routes of said objects between said origination and destination nodes to said artificial neural network; and
retraining said artificial neural network.

13. The method of claim 9 further comprising:
scheduling a new route for said object based on said detected deviations.

14. The method of claim 9 wherein said objects are trains, said object identifiers are train numbers, and said travel routes are segments of train track provided for said trains between said origination and destination nodes.

15. A computer-implemented system for predicting an arrival time of an object at a destination node within a transport network of a moving objects, said object moving along a travel route between an origination node and said destination node, said computer-implemented system having at least one computer including a processor and associated memory from which computer instructions are executed by said processor, said system comprising:
an artificial neural network module associated with said travel route between said origination node and said destination node, said artificial neural network module being trained by historical tracking information including previous travel routes of objects travelling between said origination and destination nodes, said artificial neural network predicting an arrival time at said destination node of said object based on physical attributes of said object.

16. The system of claim 15 wherein said many objects are trains, said object identifiers are train numbers, and said travel routes are segments of train tracks provided for said trains between said origination and destination nodes.

17. The system of claim 16 wherein said physical attributes include at least one of a locomotive type, a locomotive horsepower, a number of loaded train cars, and a train weight.

18. The system of claim 15 wherein said historical tracking information includes data regarding previously traversed train track segments for particular trains having particular physical attributes.

19. The system of claim 15 wherein said destination node is a train station or a railroad siding.
